(19) United States
(12) Patent Application Publication
(10) Pub. No.: US 2004/0111403 A1
(43) Pub. Date: Jun. 10, 2004

(54) Voter information system

(76) Inventor: Vincent M. Keenan, Detroit, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/642,470

(22) Filed: Aug. 14, 2003

Related U.S. Application Data
(60) Provisional application No. 60/403,603, filed on Aug. 14, 2002.
(60) Provisional application No. 60/408,805, filed on Sep. 6, 2002.

(51) Int. Cl. G06F 7/00

(52) U.S. Cl. 707/3

(57) ABSTRACT

A method for providing voters with election information specific to voter polling location. A voter registration file is queried for a name of a registered voter in response to an input from a user. The user is queried for additional information through a series of single criteria iterations each time the query renders more than one result. The user is presented with a contact with whom the user should register to vote if the user name cannot be found in the voter registration file. The user is granted access to a ballot information page if the user is found in the voter registration file. The ballot information page presents the user with relevant information based on the user polling location.

### CROSS-REFERENCE TO RELATED APPLICATIONS

This application claims the benefit of U.S. provisional application Serial No. 60/403,603 filed Aug. 14, 2002 and U.S. provisional application Serial No. 60/408,805 filed Sep. 6, 2002.

### BACKGROUND OF THE INVENTION

1. Field of the Invention

The present invention relates to a system for conveniently providing information to voters via a network regarding ballot content, voting poll information and other information regarding political campaigns.

2. Background Art

A key to democratic and representative government is an informed electorate. In many elections a large number of candidates vie for representative, judicial and other elected offices at the federal, state, and local levels of government. In addition, complex ballot proposals relating to public initiatives, tax assessments and other issues frequently appear on ballots. Mass media information sources such as radio, television and newspapers cover broad geographic areas and focus on federal and state candidates and issues. Consequently, less media attention is given to local elections and local ballot proposals, many of which are almost completely ignored by the media. Voters must wade through information regarding many local candidates and ballot proposals that they do not have the opportunity to vote for to locate the candidates and ballot proposals that do appear on their ballots.

In an attempt to more effectively provide voter information, a voter education system that allows voters to search using their voter registration information in a qualified voter file database was offered through the website publius.org. The publius website is capable of generating a representative ballot for a voter based upon the voter registration information contained in the qualified voter file. One problem encountered in prior art systems is that a voter having a name in common with other voters would, upon attempting to identify himself with the system, be provided with a list of other voters having the same name. In response to this, the system provides other identifying information such as the residence address associated with the names. This approach led to concerns regarding privacy of voter information. This approach also was difficult to access, especially for voters having relatively common names.

Government agencies have attempted to provide ballot data for major elections but a comprehensive system has not been developed that provides a convenient way to access all local ballots, candidates and proposals. In one election, ballot content information was made available based upon identification of a location on a map corresponding to a voter's address. A series of maps of progressively greater detail could be selected to zero in on relevant ballot data. In another attempt to provide voters with information, electronic voter guides provide candidates with an opportunity to post biographical data and data relating to political issues that could also be accessed via the map based menuing system described above. This approach is problematic because many candidates fail to provide biographical data and the map menuing system is difficult to access.

Campaign finance information required by the federal and state election laws is made available to the media and the voter. Voters in some states may access campaign finance information via the same map menuing system that is used to identify candidates who are elected from a specific precinct or district. The map menuing process is better suited to the needs of lobbyists, the media, and political candidates than it is to voters. Lobbyists, reporters, and candidates who are familiar with voting districts can use the map menuing system to research candidate submissions and campaign finance information. Voters, however, find the map menuing system difficult to use and frustrating when trying to identify exactly which candidates and ballot proposals they will be called upon to vote for.

There is a need for a simple and effective voter information system that is capable of providing voters with an accurate representation of their ballot before going to the polling place to cast their vote. There is also a need to provide better access to campaign information and information regarding polling places, voting machines used at various polling places, and information regarding campaign events in a single system that is easy to use and focused on the candidates and issues found on a voter's ballot.

The problems noted above and other problems relating to providing voter information are addressed by applicant's invention as summarized below.

### SUMMARY OF THE INVENTION

One aspect of the voter information system of the present invention is to provide voters with election information specific to voter polling location. The system finds a single voter in a voter registration file through a series of single criteria iterations. Each iteration asks a user for one additional piece of information about the user while revealing nothing about the voters in the voter registration file being searched. The system presents the user only with public information about the user polling location based on the user polling precinct.

The voter information system provides voters with election information specific to their polling location by initially querying a voter registration file for a name of a registered voter. If the query renders more than one result, the user is asked for additional information in a series of single criteria iterations. If the user name cannot be found in the voter registration file, the method presents the user with a contact with whom the user should register to vote. If the user's name is found in the voter registration file, the user is granted access to a ballot information page that presents the user with relevant information keyed to the user's polling location. The ballot information page may be generated based on a city and a precinct of the user. The server presenting the ballot information page need not store a unique ballot for every user in the voter registration file. This system does not compromise the privacy of any information contained in the voter registration file. The method may retrieve a user polling location from a polling location database and present the user with a virtual view of a ballot that the user will encounter when voting on election day.

The user may be presented with an option from the ballot information page to view an electronic voting guide, candidate information, and candidate submissions including biographical information provided by the individual candidates. The candidate information may be directly updated by administration personnel in each municipality via a secure link over the Internet. The user may be presented with an option from the ballot information page to view an election overview, entire ballot data, a map menu system to retrieve a map from a map database directing the user to a polling place on election day, or a listing of events retrieved from an election events database. The election events database may include information on town hall meetings, debates, appearances of candidates, and similar events.

The user may be presented with an option to retrieve information on a voting machine that the user will encounter on election day or an option to view information from a ballot database. The information may include hypertext links to candidate submissions to the database, candidate web sites, candidate campaign finance information, or public interest group web sites. This information may include text, photographs or even messages in streaming video format. Both registered and non-registered voters may be notified of their respective status by email and a link may be provided to this service. A secure sockets layer security system may be implemented for data exchange and information may be updated by automatic transactional updates in qualified voter file (QVF) format. The system may offer access to the blind by allowing the user to use text-to-voice and voice-to-text technologies. The voter registration file may be used for a constituent lookup to allow legislators to perform a voter query to know the locale of registered voters.

Another aspect of the method of the present invention is to provide a user with election information specific to user geographic location. The user is first queried for a user name. If the user name cannot be found in a voter registration file, the system may indicate to the user that he is not a registered voter. If the user name is found in the qualified voter file, the user is granted access to a ballot information page presenting the user with relevant information based on his polling location ascertained from user residence and precinct. A user polling location may be looked up in a polling location database. The user may be presented with an option from the ballot information page to see a virtual view of a ballot that he will encounter when voting on election day. The user may also be presented with an option from the ballot information page to view electronic voting guide candidate submissions including biographical information provided by the individual candidates and an election overview, entire ballot data, a map menu system, and an electronic voter guide. The method may also be accessed by students who are not registered voters but may be allowed to view voting information for educational purposes to teach about the political system and the voting process.

The system may include a first server and a second server. The first server may host a registered voter database containing a record of all registered voters in a defined area and a polling place identifier database that classifies the registered voters according to a polling place to which each of the registered voters is assigned. The second server may host an elected officials database that provides information about currently elected officials, an office database that provides information about each office that may be held by an elected official, an events database that provides information relating to an election calendar, a candidate database that provides information about candidates running for office, a ballot initiatives database that provides information about ballot initiatives, and a map database that provides maps or directions to the registered voters to assist the registered voters in finding their assigned polling place. The first server is a secure server accessible via the Internet and the second server is accessible by anyone via the Internet and provides geographically targeted information to voters registered in the registered voter database based on their polling place.

The present invention may include providing a voter information system that offers one or more of the following features: (i) define the scope of useful information; (ii) provide the information without invading privacy; (iii) establish a history of trusted non-partisan information delivery; (iv) provide as much information as possible; (v) cover all elections; (vi) cover all information relating to elections; (vii) foster 100% candidate participation; (viii) allow for fully automated local data entry and automatic updates; (ix) achieve 100% ubiquity; (x) operate based on voter lookup and offer information in a way that is tied to the polling location of the user; (xi) discern the identity of the user using a single criteria iteration methodology; and (xii) faster participation through ease of use.

These and other aspects and advantages of the present invention are better understood in view of the attached drawings and detailed description of the system provided below.

### BRIEF DESCRIPTION OF THE DRAWINGS

FIG. 1 is a diagrammatic view showing a complete voter information system; and

FIG. 2 is a flowchart showing the operational steps for the voter information system.

### DETAILED DESCRIPTION OF THE PREFERRED EMBODIMENT(S)

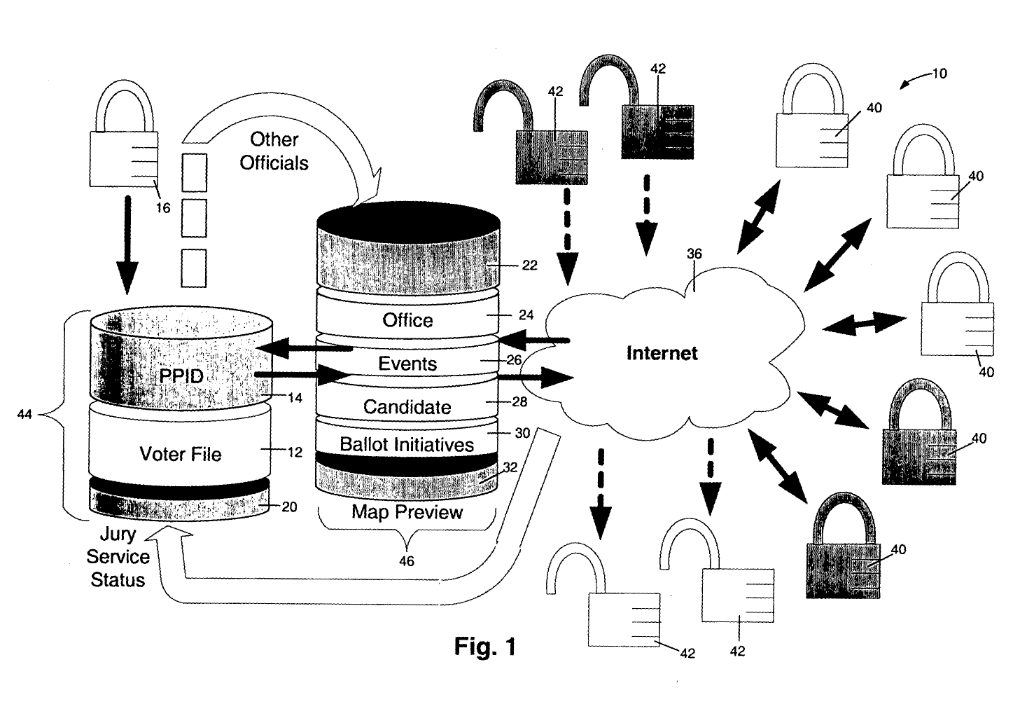

Referring now to FIG. 1, a voter information system 10 is shown in a diagrammatic form wherein the relational databases and users are shown. The voter information system 10 includes a qualified voter file 12 that includes a list of all qualified (e.g., registered ) voters maintained by a governmental agency charged with maintaining voter records. The voter file 12 includes identifying information for each registered voter. A polling place identifier database (PPID) 14 divides the voter file 12 according to the polling place to which each voter is assigned to vote. The voter file 12 and the polling place identifier 14 are maintained by a clerk having secure access to the qualified voter file. The voter file 12 and the polling place identifier 14 are hosted on a first server 44. The first server 44 may be a secure server. The secure user may be part of a direct network maintained on a mainframe computer system. Voter files are maintained by the secure clerk access link 16. For example, when a voter registers for the first time or changes his registration when changing residence, the secure clerk access link 16 is used to update the voter file in the qualified voter file 12. Other factors may also impact the voter file 12 such as jury service status, as indicated by reference numeral 20. A county clerk charged with responsibility for maintaining jury service records and noting a voter's failure to serve on a jury in the voting record may update a database that is cross-referenced by the qualified voter file 12.

The polling place database 14 may be generated based on all combinations of cities, precincts and/or districts in a state. The first server 44 may generate the ballots in advance so that it need only display the ballot to a registered voter when the voter is recognized by the system.

Databases that may be accessed by the voter information system may include an elected official database 22 that provides information relating to currently serving elected officials, the term of office, address, telephone number, and other information including web sites and e-mail addresses. An office database 24 provides information regarding each office that may be held by an elected official at the local, state, or federal levels. An events database 26 provides information relating to an election calendar including dates of town hall meetings, debates, and candidate forums. A candidate database 28 provides biographical and identifying information for each candidate running for office. The candidate database 28 may include hypertext links to candidate website, voting records, incumbency status, and campaign finance information. A ballot initiatives database 30 is similar to the candidate database 28 but is directed to ballot initiatives such as tax initiatives and other special ballot issues. The ballot initiatives database 30 may provide hypertext links to sponsoring or opposition website relating to each ballot initiative. A map database 32 provides maps or directions to voters to assist them in locating their polling place. All of the databases 22-32 may be accessed in a focused and limited way that provides voters with only relevant information. The databases 22-32 are hosted on a second server 46.

The above databases are accessible via the Internet 36 that is a network primarily based on HTML and/or Java. Clerks 40 with secure Internet read/write access can access the system through the Internet 36 and retrieve information or provide updated information for the events database 26, the candidate database 28, and the ballot initiatives database 30. End users 42 having non-secure read-only access can access the above noted databases through the Internet 36 to obtain information regarding political campaigns and government representatives. End users 42 can also obtain maps from the map database 32 as previously noted.

The Internet access system may be implemented through a secure sockets layer (SSL) system. Data entry may occur by election officials (e.g., the county clerk's office) at the county level. Database updates may be done by incremental or automatic transaction qualified voter file (QVF) format database updates, thus minimizing system maintenance time.

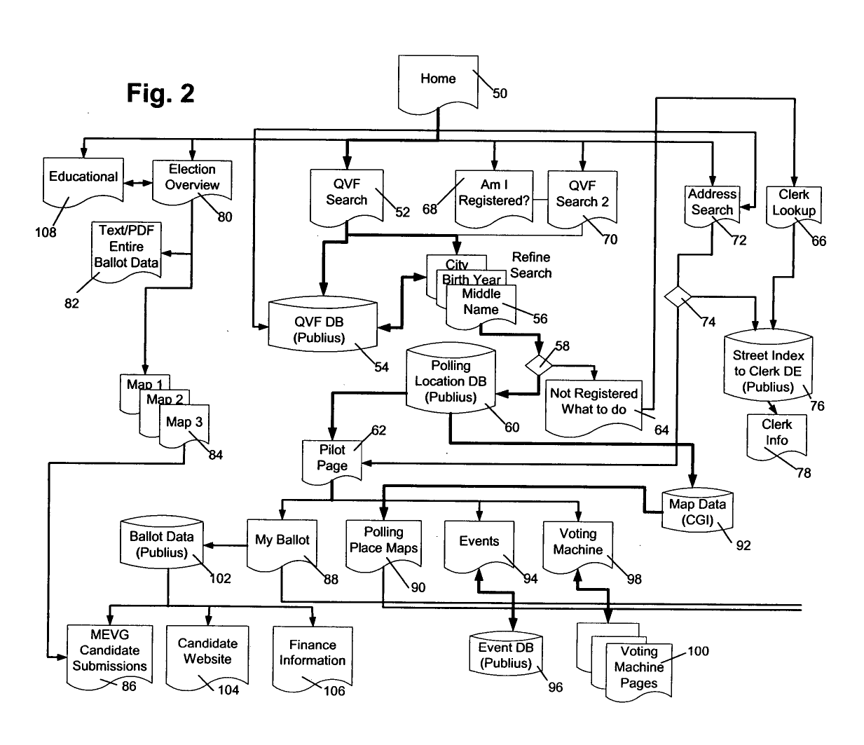

Referring now to FIG. 2, a home 50 refers to the home page on the Internet 36 for the voter information system 10. From the home page 50, the anticipated typical path would lead to a qualified voter file search at 52 wherein the user of the system would enter his first and last name to be searched or queried by a qualified voter file database 54. The qualified voter file database is maintained by the system administrator. If more than one name corresponds to the first and last name field, the system provides a refined search by querying the user for one additional piece of information such as his city of residence, birth year, or middle initial at the limiting search fields 56. It would also be possible to use other search parameters. The system will continue to ask the user for one additional piece of information and re-query the qualified voter file database 54 each time until the user is positively identified as either a registered voter found in the qualified voter file database 54 or a non-registered voter. This implementation is referred to as a single criteria iteration methodology. Whenever the system determines that only one voter matches the name and refined search field, the system passes the voter name null result at 58 and is routed to a polling location database at 60. The polling location database 60 is also maintained by the system administrator. The polling location database 60 generates a pilot page 62 that provides an identification of the user polling location that is used to organize information provided to the user that is relevant to him. Alternatively, the pilot page 62 may simply present the user with a virtual image of the ballot to which all other pages are linked. If the voter name null result 58 indicates that the voter's name does not appear in the qualified voter file database 54, the system provides instructions at 64 indicating to the user that he is not registered. The instruction may include directing the system to look up the identity of a clerk at 66 who is responsible for voter registration. Alternatively, the system may simply provide the contact information of the clerk with whom the unregistered voter may register to vote.

The system can also be accessed by responding to a registered voter query at 68 wherein the user can query the system as to whether or not he is registered. In response to this query, the system conducts a qualified voter file search at 70 and proceeds in the same manner as described as if the user initially requests the qualified voter file search at 52.

The system can also be accessed by entering a voter's address at address search 72. The address search 72 is provided in the event the user is reluctant to enter his name in response to an Internet query. The system provides an address null result at 74 in the event the address is not recognized. The address may not be recognized if it was improperly entered or if the address is a new address (e.g., an address in a new subdivision that has not been previously indexed by the system). If the address is identified after the address null result, the user would be directed to the pilot page 62. In this way, non-registered voters may access the system to obtain the same information that is available to registered voters. If the street is not recognized at the address null result 74, the user is directed to a street index to clerk database 76 that is also maintained by the system administrator. The street index to clerk database 76 is also accessed after the clerk look up 66 is reached after it is determined that the voter in the qualified voter file search is not registered at 64. Clerk information is provided at 78 based on the information contained in the street index to clerk database 76.

The system can also be accessed through an election overview page 80. Election overview 80 provides general information regarding an impending election. If the system is accessed via the election overview page 80, it is possible to access a file containing the text (for example by accessing text in PDF format) of the entire ballot data as maintained by the governmental agency responsible for elections. The user can use a map menu system at 84 to access portions of the ballot data available at 82 and also review electronic voting guide candidate submissions at 86. Electronic voting guide candidate submissions 86 include biographical information provided by individual candidates. The election overview 80, entire ballot data 82, map menuing system 84 and electronic voter guide 86 were previously developed and maintained by the State of Michigan in a manner described above in the background art section.

From the pilot page 62, the principle path followed by a user would be to review a ballot replica at 88. The ballot replica reviewed at 88 is based on the determination of the polling location from the polling location database 60. From the pilot page 62, it is also possible to retrieve polling place maps 90. Polling place maps 90 provide maps to polling places that may include directions from the user or voter's residence to the polling place. A map database at 92 is maintained by a commercial or governmental database provider so that a polling map may be generated at 90. From the pilot page 62, it is also possible to access an events listing at 94. The events listing 94 is based on events posted in the events database 96. The events database 96 is maintained by the system administrator. Events that may be posted in the events database include town hall meetings, debates, appearances of candidates, and similar events.

The pilot page 62 also provides access to voting machine information at 98. Voting machine information 98 is provided based on information in the polling location database 60 as to what voting machines are available at the polling place. A series of voting machine pages 100 may be accessed that provide information regarding the particular voting machine used at the polling place.

A ballot database 102 is also maintained by the system administrator. The ballot database 102 is accessed by the system to create the ballot replica at 88. The ballot database 102 includes all of the candidates' names and all ballot initiatives and is maintained by the system administrator. The ballot database 102 may include hypertext links to candidate submissions 86 or candidate website at 104. Candidate website 104 are sites on the Internet created by candidates to provide information regarding the candidate. Within the candidate website 104, or separately, it would be possible to access voting initiative website that may be maintained by public interest groups. Messages may be delivered to voters by way of real-time streaming digital video.

Finance information is available at 106 and may also be reached by a hypertext link from the ballot database 102. Finance information 106 includes campaign finance information to be reported by candidates as required by statute. This information can also be accessed from hot links maintained on the ballot database 102.

The system may also implement a statewide voter tickler system that is designed to notify registered voters by e-mail of the presence of the system. The system may contact non-registered voters urging them to register. The system may be widely publicized to encourage public use of the system. The system may allow for access to the disabled by, for example, employing text-to-voice and voice-to-text technologies for the blind.

An educational page 108 may be accessible from the home 50 or the election overview page 80. The educational page 108 is designed to teach students about the levels of government, the election process, and voting. The system may be used in schools as an educational aid. The educational page 108 may be connected to or integrated with the election overview page 80.

It is an objective of the present invention to maintain both the real confidentiality of voter information as well as the appearance of privacy of voter information. The single criteria iteration methodology may be employed for this purpose. Information about the users of the system may be protected for privacy so that it is never delivered to the users of the system. The system asks a user questions, one at a time, to identify the user. The system presents the user with information about his polling place and candidates in his locale after the voter is specifically identified. The system does not identify the user as residing in a particular area. The system assures the user that information about the user is not being made available to the public. Such an approach is necessary to make users feel secure, increasing trust in the system that is important to achieving widespread acceptance and use.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for providing voters with election information specific to voter polling location comprising:
querying a voter registration file for a name of a registered voter in response to an input from a user;
querying the user for additional information through a series of single criteria iterations each time the query renders more than one result; and
granting the user access to a ballot information page if the user is found in the voter registration file, wherein the ballot information page presents the user with relevant information based on the user polling location.

2. The method for providing voters with election information specific to voter polling location according to claim 1 wherein the method employs a multiple query system that does not compromise the privacy of any information contained in the voter registration file.

3. The method according to claim 1 further comprising:
retrieving a user polling location in a polling location database; and
presenting the user with an option from the ballot information page to see a virtual view of a ballot that the user will encounter when voting on election day.

4. The method according to claim 1 further comprising:
presenting the user with an option from the ballot information page to view at least one of an electronic voting guide, candidate information, and candidate submissions including biographical information provided by the individual candidates.

5. The method according to claim 4 wherein the candidate information is directly updated by administration personnel in each municipality via a secure link over the Internet.

6. The method according to claim 1 further comprising:
presenting the user with an option to view at least one of an election overview, voting machine data, and a map menu system.

7. The method according to claim 1 further comprising:
presenting the user with an option to retrieve at least one map from a map database directing the user to a polling place.

8. The method according to claim 1 further comprising:
presenting the user with an option to view a listing of events retrieved from an election events database.

9. The method according to claim 8 wherein the election events database comprises information on at least one of town hall meetings, debates, appearances of candidates, and similar events.

10. The method according to claim 1 further comprising:
presenting the user with an option to retrieve information on a voting machine that the user will encounter on election day.

11. The method according to claim 1 further comprising:
presenting the user with an option to view information from a ballot database, the information comprising at least one of hypertext links to candidate submissions, hypertext links to candidate web sites, hypertext links to candidate campaign finance information, and hypertext links to public interest groups.

12. The method according to claim 11 wherein the information from the ballot database may include messages in streaming video format.

13. The method according to claim 1 further comprising:
notifying both registered and non-registered voters of their respective status by email, wherein a hypertext link to a system for providing voter information is provided within the email.

14. The method according to claim 1 further comprising:
presenting the user with a contact with whom the user should register to vote if the user name cannot be found in the voter registration file.

15. The method according to claim 1 wherein a secure sockets layer security system is implemented for data exchange and information is updated by automatic transactional updates in qualified voter file (QVF) format.

16. The method according to claim 1 further comprising:
offering access to the blind by allowing the user to convert text-to-voice and voice-to-text.

17. The method according to claim 1 wherein the ballot information page is generated based on a city and a precinct of the user and a server presenting the ballot information page need not store a unique ballot for every user in the voter registration file.

18. The method according to claim 1 wherein the voter registration file is used for a constituent lookup to allow legislators to perform a voter query to know the precinct in which registered voters are assigned.

19. A method for providing a user with election information specific to user geographic location comprising:
querying the user for a user name;
indicating the user is not a registered voter if the user name cannot be found in a voter registration file; and
granting the user access to a ballot information page if the user is found in the voter registration file, the ballot information page presenting the user with relevant information based on user polling location ascertained from user residence and precinct.

20. The method according to claim 19 further comprising:
looking up a user polling location in a polling location database;
presenting the user with an option from the ballot information page to see a virtual view of a ballot that the user will encounter when voting on election day;
presenting the user with an option from the ballot information page to view electronic voting guide candidate submissions including biographical information provided by the individual candidates; and
presenting the user with an option from the ballot information page to view at least one of an election overview, ballot data, a map menu system, and an electronic voter guide.

21. The method according to claim 19 further comprising:
presenting students with an option to view educational information designed to teach about a political system and a voting process.

22. A voter information system comprising:
a voter database containing a record of all registered voters in a defined area;
a polling place identifier database that classifies the registered voters according to a polling place to which each of the registered voters is assigned;
an elected officials database that provides information about currently elected officials;
an office database that provides information about each office that may be held by an elected official;
an events database that provides information relating to an election calendar;
a candidate database that provides information about candidates running for office;
a ballot initiatives database that provides information about ballot initiatives; and
a map database that provides maps or directions to the registered voters to assist the registered voters in finding the polling places assigned to them, wherein:
(i) the registered voter database and the polling place identifier database are accessible on a first secure server via the Internet by voters registered in the registered voter database; and
(ii) the elected official database, the office database, the events database, the candidate database, the ballot initiatives database, and the map database are accessible on a second server by anyone via the Internet for providing geographically targeted information to the voters registered in the registered voter database based on their polling place.

23. The voter information system according to claim 22 further comprising a secure access link to the registered voter database files and the polling place identifier database files.

24. The voter information system according to claim 22 wherein the secure server provides read/write access to authorized users having secure access to the secure server and both the secure server and the second server provide read only access to all other end users.

25. A method for providing voters with election information specific to voter polling location comprising:
finding a single voter in a voter registration file through a series of single criteria iterations, each iteration asking a user for one additional piece of information about the user while revealing nothing about the voters in the voter registration file being searched; and
presenting the user only with public information about the user polling location based on the user polling precinct.

26. A voter information system comprising:
a first server hosting a registered voter database containing a record of all registered voters in a defined area and a polling place identifier database that classifies the registered voters according to a polling place to which each of the registered voters is assigned;
a second server hosting at least one of:
(i) an elected officials database that provides information about currently elected officials;
(ii) an office database that provides information about each office that may be held by an elected official;
(iii) an events database that provides information relating to an election calendar;
(iv) a candidate database that provides information about candidates running for office;
(v) a ballot initiatives database that provides information about ballot initiatives; and
(vi) a map database that provides maps or directions to the registered voters to assist the registered voters in finding the polling places assigned to them; and
wherein the first server is a secure server accessible via the Internet and the second server is accessible by anyone via the Internet and provides geographically targeted information to the voters registered in the registered voter database based on their polling place.
